(19) United States
(12) Patent Application Publication
(10) Pub. No.: US 2010/0048397 A1
(43) Pub. Date: Feb. 25, 2010

(54) GABA/Pesticidal Combinations

(76) Inventor: Gregory Keith Lewis, Wake Forest, NC (US)

Correspondence Address: BUCHANAN INGERSOLL & ROONEY PC, P.O. BOX 1404, ALEXANDRIA, VA, 22313-1404, US

(21) Appl. No.: 12/544,752

(22) Filed: Aug. 20, 2009

Related U.S. Application Data
(60) Provisional application No. 61/091,220, filed on Aug. 22, 2008.

(51) Int. Cl. A01N 57/12; A01N 37/44; A01N 43/40; A01P 13/00; A01P 7/02; A01P 7/04

(52) U.S. Cl. 504/127; 514/561; 504/147; 514/341

(57) ABSTRACT

Embodiments herein provide the formulation and use of gamma-aminobutyric acid (“GABA”) in combination with one or more of a herbicide and an insecticide. In one embodiment, the herbicide is glyphosate; in another, the insecticide is imidacloprid. Methods and formulations described and claimed herein may be useful for encouraging growth of desired plants while discouraging the growth of undesirable plants and/or pests. Method and formulations described and claimed herein may be useful for alleviating stress conditions for desirable plants, and for decreasing yield losses resulting from application of herbicides and/or insecticides.

### CROSS-REFERENCE TO RELATED APPLICATIONS

This application claims priority to pending U.S. Provisional Patent Application No. 61/091,220, filed on Aug. 22, 2008. That application is incorporated by reference herein.

### STATEMENT OF FEDERALLY SPONSORED RESEARCH

Not applicable.

### BACKGROUND OF THE INVENTION

The following includes information that may be useful in understanding the technology taught herein. It is not an admission that any of the information provided herein is prior art, or material, to the presently described or claimed subject matter, or that any publication or document that is specifically or implicitly referenced is prior art.

1. Field of the Invention

Present teachings relate to, but are not limited to, the field of plant growth and maintenance. Additional teachings relate to relief of plant stress, and to reduction of adverse effects on desirable plants that may result from treatments to reduce or control undesirable plants or insects. Embodiments relate, for example, to methods for treating plants and plant parts to allow enhanced growth and decreased insect and weed infestation. Further embodiments relate to methods for treating plants and plant parts to reduce plant stress, phytotoxic effects, and/or anticipated plant stress. Additional embodiments relate to methods for ameliorating detrimental effects of herbicides, insecticides and acaricides on desirable plants. Particular embodiments include mixtures and formulations comprising gamma-aminobutyric acid (“GABA”) (IUPAC Name: 4-Aminobutanoic Acid) CAS# 56-12-2, with glyphosate herbicide and separately with imidacloprid insecticide. Embodiments may include proteinaceous amino acids and/or sources of proteinaceous amino acids. Embodiments may include glutamic acid.

2. Background of the Art

Certain combinations of active ingredients for controlling weeds and pests are described in the literature. The biological properties of those combinations are not entirely satisfactory for a number of possible reasons. For example, they may provide insufficient specificity, thereby encouraging the growth of unwanted plant species in close proximity to desirable plant life. They may also lack the capability to control insects or other pests. They may also not adequately encourage the growth of and/or relieve the stress on plants that are treated with those combinations. They may also add to plant stress by the causation of phytotoxic effects resulting from the biologically active compound itself or from one or more materials used to prepare the formulation which is applied to the plant. They may also fail to provide adequate beneficial effects for plants unless used in levels that exceed what is safe or advisable for use near humans, near domestic animals, or in the environment.

Some plants display a natural tolerance to certain herbicides while other plants have been developed that are tolerant to certain herbicides. For example, some plants have been engineered to be tolerant to the herbicide glyphosate. This allows glyphosate to be applied to those plants and to the vicinity of those plants to reduce or eliminate undesirable plants that do not enjoy glyphosate resistance.

Unfortunately, it is recognized that application of glyphosate (and similar compositions) may result in negative effects on growth and yield known as “yield drag” even for plants that are resistant to the compound. For example Schilling et al (2006) reported, for glyphosate-tolerant canola, reductions in stem and shoot weight from single applications of glyphosate and, in addition, reductions in leaf weight and area as well as stem and shoot weight reductions from multiple applications of glyphosate. Reddy et al (2001) reports reductions in chlorophyll content as well as shoot and root weights with double label rates of glyphosate application on soybeans. Nodulation was slightly reduced at label rates.

There are numerous reports of a yield drag associated with glyphosate use in soybeans (Benbrook, 1999; Carpenter and Gianessi, 1999; Carpenter, 2001). This yield drag may be, for example, between 3% and 5% of the expected yield although in the cited references some much higher reductions have been seen, depending on the varieties tested.

The phytotoxic effects and yield reductions may result from one or more factors acting alone or in combination. For example, the active component of the herbicide or insecticide is typically not applied alone, but is usually applied in a formulation with a surfactant, dispersant, and/or other compounds that may have a deleterious effect on the desirable plant. Examples of adjuvants reported to have phytotoxic effects include hydrocarbons used as solvents (Sandler et al, 1995) and surfactants used to improve wetting (Weichel and Nauen, 2004). Remediation of this effect is not as simple as merely removing the surfactant, dispersant, and/or other compound, in part because of the complexity of the formulation that is necessary to otherwise maximize efficacy.

In cases where the stress is caused by an incomplete tolerance to the glyphosate (or other compound) in the desired plant, it is not possible to remove the offending compound without frustrating the purpose of the chemical application. Farmers also often apply glyphosate in combination with a salt like ammonium sulfate to aid incorporation of the glyphosate. This combination may also contribute to phytotoxicity in certain circumstances.

Most recent theories have focused on the cause of phytotoxicity and yield drag, resulting from glyphosate applications in glyphosate-tolerant crops, as being due to AMPA which is the primary metabolite from glyphosate (Reddy et al, 2004; Duke, 2005). Thus, it appears that the cause is associated more with the application of the glyphosate rather than to an effect of the development of the transgenic plant itself.

Benbrook, 1999, has reported at some length on observations in the field of a yield reduction attributable to the application of glyphosate over glyphosate-tolerant soybeans. These data indicate that in over 8,200 trials recorded in 1998, glyphosate application reduced yields by around 3 bushels/acre (180 lbs) or 5%. In work reported by Schilling and Harker, 2006, glyphosate was applied as single applications at the two-, four-, or six-leaf stage of canola (glyphosate-tolerant); and as sequential double applications at the two- and four-, two- and six-, and four- and six-leaf stages of canola; and as a triple application at all three stages. Of the plant growth parameters measured, single applications of glyphosate resulted in significant reductions to stem weight and shoot weight compared with non-treated plants, and multiple applications of glyphosate caused significant reductions to leaf area, leaf weight, stem weight, and shoot weight.

Certain crops have been genetically engineered or selected to provide tolerance to herbicides other than glyphosate; glufosinate, bromoxynil and dicamba are three examples. Ritter and Menbere, 2001, report on crop injury from glufosinate applications in tolerant corn and soybean, and Rothe et al, 2004 report the same in glufosinate resistant sugar beet. Richardson et al, 2003 report cotton damage from bromoxynil sprays in bromoxynil-resistant cotton.

There are many herbicides in common use, which show selectivity in the plants that they kill. For example, selective grass herbicides will kill grasses leaving a desirable broad-leafed crop relatively unharmed. Selectivity is however never absolute and desirable plants may be harmed to some extent by one or more components of a selective weed killer. The control of weeds in a growing crop therefore requires the use of the best available selective herbicides, which are chosen to kill the weeds while leaving the crop undamaged. In practice, few herbicides are fully selective, in that they will kill all the weeds and leave the crop untouched at a particular application rate. The use of most selective herbicides is therefore, actually a balance between applying enough herbicides to acceptably control most of the weeds and causing only minimal crop damage. Evidence for this is commonly found on labels of selective herbicides which warn about crop damage especially if application timing, rates and conditions vary from an optimum which, in agriculture is often the case. An example of the difficulties in finding selective herbicides for crops is documented by Holm et al, 2003 for chickpeas.

An example of an insecticide which has been reported as causing phytotoxic effects in desirable plants is (E)-1-(6-chloro-3-pyridylmethyl)-N-nitroimidazolidin-2-ylideneamine imidacloprid (IUPAC Name) CAS#138261-41-3, commonly known as imidacloprid. Use of this material has resulted in leaf necrosis in cauliflowers (Natwick et al, 1996), phytotoxic reactions in tobacco (Burrack and Sorenson, 2009), in leek (Huiting and Ester, c.1997; Ester et al, 1997), and in cucumbers and tomatoes (Ebel et al, 2000) and reduced germination in rice (Stevens et al, 2008) following seed treatment and prolonged storage before sowing.

Huiting and Ester, c. 1997; Ester et al, 1997 report that imidacloprid-treated leek seed exhibited phytotoxicity as delayed germination rates when compared with seed treated with fipronil. These data indicate that imidacloprid can significantly reduce germination rates.

Other examples of insecticides and acaricides producing undesirable effects in plants which are treated to control insect or arachnid pests include propargite and profenofos in cotton (Freeman, 2005), acephate and fipronil in cotton (Mississippi State University, 1996), acephate and chlorpyrifos in ornamentals (Hale, 1998) and in sugar beet (Stolz and Gallion, 1990), acephate in Gerberas (Spiers et al, 2006), trichlorofon in sorghum (Riccelli-Mattei, 1971), parathion and methyl parathion in sorghum (Meisch et al, 1970), and phorate, aldicarb, chlorpyrifos and terbufos in pearl millet (Kennedy, 2002).

It is also recognized that the application of compounds that may be beneficial to desirable plants (for example, by enhancing growth, increasing yield, or reducing stress) may also have beneficial effects on undesirable plants or other undesirable organisms. These unintended effects can result in a vicious cycle whereby a herbicide or pesticide is applied to reduce undesirable organisms but also affects the desirable plant, requiring application of a growth-enhancing, stress-reducing compound, which has the unintended effect of aiding the undesirable organisms.

There is therefore a continuing need to provide insecticidal and herbicidal combinations that provide improved properties, for example, biological properties and/or synergistic properties, especially for enhancing plant growth and controlling weeds and pests. There is also a continuing need to provide insecticidal and herbicidal combinations that relieve stress on desirable plants and still reduce or eliminate undesirable plants or pests. There is a further need to provide insecticidal and herbicidal combinations that ameliorate negative effects that certain herbicidal and insecticidal treatments may have on plants that are designed to be resistant to, or that are naturally resistant to, those herbicidal or insecticidal treatments.

### BRIEF SUMMARY OF THE INVENTION

A first embodiment as taught herein provides a formulation comprising at least two active ingredient components, wherein component (I) is one or more of a pesticide, particularly an insecticide and/or an acaricide and/or a herbicide, and component (II) is gamma-aminobutyric acid, commonly known as “GABA.” These formulations are designed to have improved properties relative to separate application of their constituent parts, where such improved properties are primarily directed to reduction in negative effects of the pesticidal-type application. Negative effects may include, for example, but are not limited to impaired germination and/or phytotoxicity and/or impaired growth or yield of the desirable plant.

In a preferred embodiment, the herbicide is 2-(phosphonomethylamino)acetic acid (IUPAC Name) CAS#1071-83-6, commonly known as glyphosate.

In another preferred embodiment the insecticide is (E)-1-(6-chloro-3-pyridylmethyl)-N-nitroimidazolidin-2-ylideneamine imidacloprid (IUPAC Name) CAS#138261-41-3, commonly known as imidacloprid.

In embodiments where the pesticide includes one or more herbicides, the formulation typically is applied to plants or plant parts that are resistant to the herbicide(s) included in the formulation. By “resistant” it is understood that the desirable plant is naturally resistant to the herbicide, or it has been genetically engineered or selected such that the herbicide should have little or no detrimental effect on the plant or plant parts.

In embodiments in which the pesticide includes one or more insecticides and/or acaricides, the formulation is typically applied to the seed or plant in order to kill insects and/or arachnid pests which are feeding on the plant and preventing full growth and development or even, in some cases resulting in death of the plant.

In further embodiments, formulations include one or more proteinaceous amino acids or sources of proteinaceous amino acids. Suitable sources of proteinaceous amino acids include, but are not limited to, protein hydrolysates, yeast extracts, blood hydrolysates, dairy and meat hydrolysates, and vegetable protein hydrolysates.

In still further embodiments, formulations include an effective amount of glutamic acid. Glutamic acid is effective in reducing plant stress. Uses of glutamic acid are reported, for example, in U.S. Pat. No. 6,534,446, to Kinnersley, et al., which is incorporated by reference herein.

In a further embodiment, formulations as described herein are applied to one or more plants to reduce the growth of undesirable plants that may affect the growth and well-being of the subject plant. Formulations may also provide protection against, or remediation of, insect infestations. In addition to the reduction of undesirable plants and/or insects, the formulations as taught herein may be applied to mitigate plant stress.

A further embodiment of the invention provides a method for reducing plant stress comprising providing a plant undergoing stress or expected to undergo stress with an amount of any of the inventive formulations effective to reduce that stress. This stress reduction may be manifested, for example, by reduction of yield drag normally expected from the pesticide that is being applied as part of the inventive formulation. In a further embodiment, a method is provided for preventing or foreclosing anticipated plant stress and/or anticipated phytotoxic symptoms by applying a composition as taught herein, where stress and/or phytotoxic symptoms are “anticipated” if one skilled in the art would, given the prospective application of insecticides or acaricides to plants, the prospective application of herbicides to herbicide resistant plants, and/or the application of herbicides to herbicide tolerant plants.

### DETAILED DESCRIPTION OF THE INVENTION

Embodiments of the invention provide a formulation comprising at least two active ingredient components, wherein component (I) is one or more of a pesticide, and component (II) is gamma-aminobutyric acid, commonly known as “GABA.” Pesticides for use in embodiments taught herein may include, but are not limited to, herbicides, insecticides, acaracides, nematicides, and molluscicides.

GABA may be obtained commercially, synthesized by methods known in the art or derived from fermentation also known in the art. In a preferred form, GABA is obtained commercially or synthesized. Some purported uses and effects of GABA either alone or in combination with glutamic acid are described in U.S. Pat. No. 6,534,446, the entire disclosure of which is incorporated by reference herein. In addition other uses are described in U.S. Pat. No. 5,840,656, the entire disclosure of which is incorporated by reference herein.

GABA may be present in formulations in an amount effective to mitigate plant stress and/or enhance plant growth. Concentrations of GABA and the amount of GABA sufficient to mitigate plant stress and/or enhance plant growth will be dependent on the type of plant and on the nature of the stress to be mitigated and/or the level to which growth is to be enhanced, as will be apparent to one of ordinary skill in the art. For example, administration of effective amounts of GABA may be observed by treating a plant with the formulations of the present invention and observing either increases in dry weight of the plant, increases in the number of germinated seeds, decrease in pest damage compared to untreated plants. Sources of stress known to be alleviated to a greater or lesser extent by the application of GABA are documented in U.S. Pat. Nos. 5,840,656 and 6,534,446 and include, for example, nutrient stress, disease stress, acidification, mechanical damage, cold and heat shock, anaerobosis, salt and water stress and viral attack. It is notable that phytotoxicity due to pesticidal application is not included. The foregoing amounts may be applied in one application or split over two or more applications.

Possible concentrations of GABA acid include, but are not limited to, about 1 ppm to about 24,000 ppm [about 0.013 oz/acre (oz/A) to about 20 lbs/A] [about 0.93 g/hectare (g/ha) to about 22 kg/ha], about 1 ppm to about 12,000 ppm (about 0.013 oz/A to about 10 lbs/A) (about 0.93 g/ha to about 11 kg/ha), about 1 ppm to about 7,500 ppm (about 0.013 oz/A to about 6.3 lbs/A) (about 0.93 g/ha to about 7.1 kg/ha); about 1 ppm to about 5,000 ppm (about 0.013 oz/A to about 4.2 lbs/A) (about 0.93 g/ha to about 4.8 kg/ha); about 1 ppm to about 2,500 ppm (about 0.013 oz/A to about 2.1 lbs/A); (about 0.93 g/ha to about 2.4 kg/ha); and about 150-600 ppm (about ⅛ lb/A to about ½ lb/A) (about 0.14 kg/ha to about 0.56 kg/ha). The above concentrations are exemplary only and other concentrations of GABA within the formulations would fall within the scope of the present invention.

One commercially available formulation of GABA in combination with glutamic acid is known as AUXIGRO®. Use instructions for AUXIGRO® formulation are laid out on the AUXIGRO® label, which is wholly incorporated herein by reference.

In further embodiments, the GABA is substituted either partially or entirely by a metabolic primer or an amino acid precursor. Suitable substitutes include, for example, aspartame and/or azaleic acid.

In a preferred embodiment, the pesticide is a herbicide. One preferred herbicide is glyphosate, commonly known as 2-(phosphonomethylamino)acetic acid. Glyphosate salts may also be used. Suitable glyphosate salts include, for example, but are not limited to, isopropylamine salts, diammonium salts, and trimethylsulfonium salts. Formulations including glyphosate typically include one or more surfactants, typically one or more nonionic surfactants, though no surfactant should be required. Glyphosate-containing formulations are typically applied to desirable plants and plant-parts that are glyphosate resistant. Glyphosate is often applied in combination with a water-soluble fertilizer salt such as ammonium sulfate (AMS) but no such addition should be required.

In embodiments where the pesticide includes one or more herbicides, the formulation typically is applied to plants or plant parts that are resistant to the herbicide(s) included in the formulation. By “resistant” it is understood that the desirable plant is naturally resistant to the herbicide, or it has been genetically engineered or selected such that the herbicide should have little or no detrimental effect on the plant or plant parts. Alternatively, the pesticide is a selective herbicide. By “selective” it is understood that the herbicide is used to selectively kill susceptible undesirable plants yet do minimal damage to the desirable plants.

Examples of herbicides useful in formulations described herein include, for example, but are not limited to: amide herbicides, including allidochlor, amicarbazone, beflubutamid, benzadox, benzipram, bromobutide, cafenstrole, CDEA, cyprazole, dimethenamid, dimethenamid-P, diphenamid, epronaz, etnipromid, fentrazamide, flucarbazone, flupoxam, fomesafen, halosafen, isocarbamid, isoxaben, napropamide, naptalam, pethoxamid, propyzamide, quinonamid, saflufenacil, and tebutam; anilide herbicides, including chloranocryl, cisanilide, clomeprop, cypromid, diflufenican, etobenzanid, fenasulam, flufenacet, flufenican, ipfencarbazone, mefenacet mefluidide, metamifop, monalide, naproanilide, pentanochlor, picolinafen, propanil, sulfentrazone; arylalanine herbicides, including benzoylprop, flamprop, and flamprop-M; chloroacetanilide herbicides, including acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, and xylachlor; sulfonanilide herbicides, including benzofluor, cloransulam, diclosulam, florasulam, flumetsulam, metosulam, perfluidone, pyrimisulfan, and profluazol; sulfonamide herbicides, including asulam, carbasulam, fenasulam, oryzalin, penoxsulam, and pyroxsulam; thioamide herbicides, including bencarbazone and chlorthiamid; antibiotic herbicides, including bilanafos; aromatic acid herbicides; benzoic acid herbicides, including chloramben, dicamba, 2,3,6-TBA, and tricamba; pyrimidinyloxybenzoic acid herbicides, including bispyribac, and pyriminobac; pyrimidinylthiobenzoic acid herbicides, including pyrithiobac; phthalic acid herbicides, including chlorthal, picolinic acid herbicides, aminopyralid, clopyralid, and picloram; quinolinecarboxylic acid herbicides, including quinclorac, and quinmerac; arsenical herbicides, including cacodylic acid, CMA, DSMA, hexaflurate, MAA, MAMA, MSMA, potassium arsenite, and sodium arsenite; benzoylcyclohexanedione herbicides, including mesotrione, sulcotrione, tefuryltrione, and tembotrione; benzofuranyl alkylsulfonate herbicides, including benfuresate, and ethofumesate; benzothiazole herbicides, including benazolin, benzthiazuron, fenthiaprop, mefenacet, and methabenzthiazuron; carbamate herbicides, including asulam, carboxazole, chlorprocarb, dichlormate, fenasulam, karbutilate, and terbucarb; carbanilate herbicides, including barban, BCPC, carbasulam, carbetamide, CEPC, chlorbufam, chlorpropham, CPPC, desmedipham, phenisopham, phenmedipham, phenmedipham-ethyl, propham, and swep; cyclohexene oxime herbicides, including alloxydim, butroxydim, clethodim, cloproxydim, cycloxydim, profoxydim, sethoxydim, tepraloxydim, and tralkoxydim; cyclopropylisoxazole herbicides, including isoxachlortole, and isoxaflutole; dicarboximide herbicides, including cinidon-ethyl, flumezin, flumiclorac, flumioxazin, and flumipropyn; dinitroaniline herbicides, including benfluralin, butralin, dinitramine, ethalfluralin, fluchloralin, isopropalin, methalpropalin, nitralin, oryzalin, pendimethalin, prodiamine, profluralin, and trifluralin; dinitrophenol herbicides, including dinofenate, dinoprop, dinosam, dinoseb, dinoterb, DNOC, etinofen, and medinoterb; diphenyl ether herbicides, including ethoxyfen, nitrophenyl ether herbicides, including acifluorfen, aclonifen, bifenox, chlomethoxyfen, chlomitrofen, etnipromid, fluorodifen, fluoroglycofen, fluoronitrofen, fomesafen, furyloxyfen, halosafen, lactofen, nitrofen, nitrofluorfen, oxyfluorfen, dithiocarbamate herbicides, including dazomet, and metam; halogenated aliphatic herbicides, including alorac, chloropon, dalapon, flupropanate, hexachloroacetone, iodomethane, methyl bromide, monochloroacetic acid, SMA, and TCA; imidazolinone herbicides, including imazamethabenz, imazamox, imazapic, imazapyr, imazaquin, and imazethapyr; inorganic herbicides, including ammonium sulfamate, borax, calcium chlorate, copper sulfate ferrous sulfate, potassium azide, potassium cyanate, sodium azide, sodium chlorate, and sulfuric acid; nitrile herbicides, including bromobonil, bromoxynil, chloroxynil, dichlobenil, iodobonil, ioxynil, and pyraclonil; organophosphorus herbicides, including amiprofos-methyl, anilofos, bensulide, bilanafos, butamifos, 2,4-DEP, DMPA, EBEP, fosamine, glufosinate, glufosinate-P, glyphosate, and piperophos; oxadiazolone herbicides, including dimefuron, methazole, oxadiargyl, and oxadiazon; oxazole herbicides, including carboxazole, isouron, isoxaben, isoxachlortole, isoxaflutole, monisouron, pyroxasulfone, and topramezone; phenoxy herbicides, including bromofenoxim, clomeprop, 2,4-DEB, 2,4-DEP, difenopenten, disul, erbon, etnipromid, fenteracol, and trifopsime; phenoxyacetic herbicides, including 4-CPA, 2,4-D, 3,4-DA, MCPA, MCPA-thioethyl, and 2,4,5-T; phenoxybutyric herbicides, including 4-CPB, 2,4-DB, 3,4-DB, MCPB, and 2,4,5-TB; phenoxypropionic herbicides, including cloprop, 4-CPP, dichlorprop, dichlorprop-P, 3,4-DP, fenoprop, mecoprop, and mecoprop-P; aryloxyphenoxypropionic herbicides, including chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, and trifop; phenylenediamine herbicides, including dinitramine, and prodiamine; pyrazole herbicides, including azimsulfuron, difenzoquat, halosulfuron, metazachlor, pyrazosulfuron, and pyroxasulfone; benzoylpyrazole herbicides, including benzofenap, pyrasulfotole, pyrazolynate, pyrazoxyfen, and topramezone; phenylpyrazole herbicides, including fluazolate, nipyraclofen, and pyraflufen; pyridazine herbicides, including credazine, pyridafol, and pyridate; pyridazinone herbicides, including brompyrazon, chloridazon, dimidazon, flufenpyr, metflurazon, norflurazon, oxapyrazon, and pydanon; pyridine herbicides, including aminopyralid, cliodinate, clopyralid, diflufenican, dithiopyr, flufenican, fluroxypyr, haloxydine, picloram, picolinafen, pyriclor, pyroxsulam, thiazopyr, and triclopyr; pyrimidinediamine herbicides, including iprymidam, and tioclorim; quaternary ammonium herbicides, including cyperquat, diethamquat, difenzoquat, diquat, morfamquat, and paraquat; thiocarbamate herbicides, including butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, and vernolate; thiocarbonate herbicides, including dimexano, EXD, and proxan; thiourea herbicides, including methiuron; triazine herbicides, including dipropetryn, triaziflam, and trihydroxytriazine; chlorotriazine herbicides, including atrazine, chlorazine, cyanazine, cyprazine, eglinazine, ipazine, mesoprazine, procyazine, proglinazine, propazine, sebuthylazine, simazine, terbuthylazine, and trietazine; methoxytriazine herbicides, including atraton, methometon, prometon, secbumeton, simeton, and terbumeton; methylthiotriazine herbicides, includingametryn, aziprotryne, cyanatryn, desmetryn, dimethametryn, methoprotryne, prometryn, simetryn, terbutryn, triazinone herbicides, including ametridione, amibuzin, hexazinone, isomethiozin, metamitron, metribuzin, triazole herbicides, including amitrole, cafenstrole, epronaz, and flupoxam; triazolone herbicides, including amicarbazone, bencarbazone, carfentrazone, flucarbazone, ipfencarbazone, propoxycarbazone, sulfentrazone, and thiencarbazone; triazolopyrimidine herbicides, including cloransulam, diclosulam, florasulam, flumetsulam, metosulam, penoxsulam, pyroxsulam, uracil herbicides, including benzfendizone, bromacil, butafenacil, flupropacil, isocil, lenacil, saflufenacil, and terbacil; urea herbicides, including benzthiazuron, cumyluron, cycluron, dichloralurea, diflufenzopyr, isonoruron, isouron, methabenzthiazuron, monisouron, and noruron; phenylurea herbicides, including anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, and thidiazuron; sulfonylurea herbicides; pyrimidinylsulfonylurea herbicides, including amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron, and trifloxysulfuron; triazinylsulfonylurea herbicides, including chlorsulfuron, cinosulfuron, ethametsulfuron, iodosulfuron, metsulfuron, prosulfuron, thifensulfuron, triasulfuron, tribenuron, triflusulfuron, and tritosulfuron; thiadiazolylurea herbicides, including buthiuron, ethidimuron, tebuthiuron, thiazafluron, and thidiazuron; and unclassified herbicides, including acrolein, allyl alcohol, aminocyclopyrachlor, azafenidin, bentazone, benzobicyclon, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, endothal, fluoromidine, fluridone, flurochloridone, flurtamone, fluthiacet, indanofan, methyl isothiocyanate, OCH, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan, and tritac. The above list is exemplary only and other herbicides may be used and would fall within the scope of the present invention.

Examples of preferred herbicides include, but are not limited to, 2,4-D, aminopyralid, asulam, bromoxynil, chlorsulfuron, clopyralid, dicamba, diclofop, fluazifop, fluroxypyr, glyphosate, glufosinate, imazapic, imazapyr, isoxaben, linuron, MCPA, mecoprop, mecoprop-P, mesotrione, metsulfuron, ioxynil and triclopyr

In another preferred embodiment the pesticide is an insecticide. One preferred insecticide is (E)-1-(6-chloro-3-pyridylmethyl)-N-nitroimidazolidin-2-ylideneamine imidacloprid (IUPAC Name) CAS#138261-41-3, commonly known as imidacloprid. Formulations including imidacloprid typically include one or more surfactants, typically one or more nonionic surfactants, though no surfactant should be required.

In embodiments in which the pesticide includes one or more insecticides and/or acaricides, the formulation is typically applied to the plant in order to kill insects and/or arachnid pests which are feeding on the plant and preventing full growth and development or even, in some cases resulting in death of the plant.

Examples of specific insecticides, acaracides, nematicides and molluscicides that may be used in formulations taught herein include, but are not limited to, abamectin; acephate; acetamiprid, acrinathhn; alanycarb; aldicarb, alpha-cypermethrin; alphamethrin; amitraz; azinphos A; azinphos-methyl; azocyclotin; bendiocarb; benfuracarb; bensultap; beta cyfluthrin; bifenthrin; brofenprox; bromophos A; bufencarb; buprofezin; butocarboxin; butylpyridaben; cadusafos; carbaryl; carbofuran; carbophenothion; carbosulfan; carboxin; cartap; chloethocarb; chloranthraniliprole; chloroethoxyfos; chlorfenvenphos; chlorofluazuron; chloromephos; chlorpyrifos; cis-res-methrin; clocythrin; clofentezin; clothianidin; cyanoimine; cyanophos; cycloprothhn; cyfluthrin; cyhexatin; deltamethrin; demeton M; demeton S; demeton-S-methyl; diafenthiuron; dibutylaminothio; dichlofenthion; dicliphos; diethion; diflubenzuron; dimethoate; dimethylvinphos; dinotefuran; dioxathion; doramectin; edifenphos; emamectin; endosulfan; esfenvalerate; ethiofencarb; ethion; ethiprole; ethofenprox; ethoprophos; etrimphos; fenamiphos; fenazaquin; fenbutatin oxide; fenitrothion; fenobucarb; fenothiocarb; fenoxycarb; fenpropathrin; fenpyrad; fenpyroximate; fenthion; fenvalerate; fipronil; fluazinam; flubendiamide; flucycloxuron; flucythrinate; flufenoxuron; flufenprox; fluxofenime; fonophos; formothion; fosthiazate; fubfenprox; gamma cyhalothrin; HCH; heptenophos; hexaflumuron; hexythiazox; imidacloprid; iprobenfos; isoprocarb; isoxathion; ivermectin, lambda cyhalothrin; lindane; lufenuron; malathion; mecarbam; mesulfenphos; metaldehyde; methamidophos; methiocarb; methomyl; metolcarb; mevinphos; milbemectin; milbemycin oxime; moxidectin; naled; NC 184; nitenpyram; nitromethylene; omethoate; oxamyl; oxydemethon M; oxydeprofos; parathion; parathion-methyl; permethrin; phenthoate; phorate; phosalone; phosmet; phoxim; pirimicarb; pirimiphos A; pirimiphos M; profenofos; promecarb; propaphos; propargite; propoxur; prothiofos; prothoate; pymetrozine; pyrachlophos; pyrada-phenthion; pyresmethrin; pyrethrum; pyridaben; pyrimidifen; pyripfoxyfen; pyriproxyfen; rynaxypyr; salithion; sebufos; silafluofen; spinosad; sulfotep; sulprofos; tebufenozide; tebufenpyrad; tebupihmphos; teflubenzuron; tefluthrin; temephos; terbam; terbufos; tetrachloro-vinphos; thiacloprid; thiafenox; thiamethoxam; thiodicarb; thiofanox; thionazin; thuringiensin; tralomethrin; triarthen; triazamate; triazophos; triazuron; trichlorofon; triflumuron; trimethacarb; vamidothion; xylylcarb; zeta-cypermethrin; zetamethrin; and Bacillus thuringiensis (Bt) products, including the salts and esters thereof. The above list is exemplary only and other insecticides may be used and would fall within the scope of the present invention.

Examples of preferred insecticides, acaracides, nematicides and molluscicides include, but are not limited to, abamectin, acetamiprid, aldicarb, beta cyfluthrin, carboxin, chloranthraniliprole, clothianidin, Bt products, dinotefuran, fipronil, imidacloprid, lambda cyhalothrin, nitenpyram, spinosad, tefluthrin, thiacloprid, thiamethoxam, and thiodicarb.

In another embodiment, the present invention provides a method of enhancing desired plant growth and controlling or preventing pest damage and/or undesirable plant growth in or near a plant propagation material, a plant, parts of a plant and/or plant organs that grow at a later point in time, which comprises applying on the plant, part of the plant, or surroundings thereof, the formulations described herein, in any desired sequence or simultaneously.

A further embodiment provides a method of protecting a plant propagation material, a plant, parts of a plant and/or plant organs that grow at a later point in time against pest damage and weed infestation, and of encouraging plant growth, by applying to the plant, parts of plant, or their surroundings, or on the seed of the plant as a coating, one or more formulations as taught herein, in any desired sequence or simultaneously.

Embodiments herein also relate to a plant material treated with the combination defined in the first embodiment.

A further embodiment provides a method comprising (i) treating a plant propagation material with a formulation as taught herein, and (ii) planting or sowing the treated propagation material, wherein the formulation protects against undesirable plant growth in the vicinity of and/or pest damage of the treated plant propagation material, parts of plant and/or plant grown from the treated propagation material. The growth of undesirable plants in the vicinity of the plant propagation materials is decreased if a herbicide is included, and the growth of plants from the plant propagation material is enhanced.

In a further embodiment, each formulation is a composition comprising, GABA, one or more of an insecticide or herbicide, and optionally one or more formulation additives.

Formulations may include one or more proteinaceous amino acids and/or sources of proteinaceous amino acids. Suitable sources of proteinaceous amino acids include, but are not limited to, protein hydrolysates, yeast extracts, blood hydrolysates, dairy and meat hydrolysates, and vegetable protein hydrolysates.

In still further embodiments, formulations include an effective amount of glutamic acid. Glutamic acid is effective in reducing plant stress. Uses of glutamic acid are reported, for example, in U.S. Pat. No. 6,534,446, to Kinnersley, et al., which is incorporated by reference herein.

The formulations comprising at least one of an insecticide, nematicide, acaracide or mulluscicide compound (such as abamectin, clothianidin, imidacloprid, thiamethoxam, tefluthrin, lambda-cyhalothrin) are effective for control of pests. In that instance, the combination can also be applied on the pest to control or prevent pest damage and protect the desired material (e.g. plant and parts of plant) from pest damage. Examples of pests include, as examples only: from the order Lepidoptera, for example, Acleris spp., Adoxophyes spp., Aegeria spp., Agrotis spp., Alabama argillaceae, Amylois spp., Anticarsia gemmatalis, Archips spp., Argyrotaenia spp., Autographa spp., Busseola fusca, Cadra cautella, Carposina nipponensis, Chilo spp., Choristoneura spp., Clysia ambiguella, Cnaphalocrocis spp., Cnephasia spp., Cochylis spp., Coleophora spp., Crocidolomia spp., Cryptophlebia leucotreta, Crysodeixis includens, Cydia spp., Diatraea spp., Diparopsis castanea, Earias spp., Elasmopalpus spp., Ephestia spp., Eucosma spp., Eupoecilia ambiguella, Euproctis spp., Euxoa spp., Grapholita spp., Hedya nubiferana, Heliothis spp., Hellula undalis, Hyphantria cunea, Keiferia lycopersicella, Leucoptera scitella, Lithocollethis spp., Lobesia botrana, Lymantria spp., Lyonetia spp., Malacosoma spp., Mamestra brassicae, Manduca sexta, Operophtera spp., Ostrinia nubilalis, Pammene spp., Pandemis spp., Panolis flammea, Pectinophora gossypiella, Phthorimaea operculella, Pieris rapae, Pieris spp., Plutella xylostella, Prays spp., Scirpophaga spp., Sesamia spp., Sparganothis spp., Spodoptera spp., Synanthedon spp., Thaumetopoea spp., Tortrix spp., Trichoplusia ni and Yponomeuta spp.; from the order Coleoptera, for example, Agriotes spp., Anthonomus spp., Atomaria linearis, Ceutorhynchus spp., Chaetocnema tibialis, Cosmopolites spp., Curculio spp., Dermestes spp., Diabrotica spp., Epilachna spp., Eremnus spp., Gonocephalum spp., Heteronychus spp., Leptinotarsa decemlineata, Lissorhoptrus spp., Melolontha spp., Orycaephilus spp., Otiorhynchus spp., Phlyctinus spp., Phyllotreta spp., Popillia spp., Protostrophus spp., Psylliodes spp., Rhizopertha spp., Scarabeidae, Sitophilus spp., Sitotroga spp., Tenebrio spp., Tribolium spp. and Trogoderma spp.; from the order Orthoptera, for example, Blatta spp., Blattella spp., Gryllotalpa spp., Leucophaea maderae, Locusta spp., Periplaneta spp. and Schistocerca spp.; from the order Isoptera, for example, Reticulitermes spp.; from the order Psocoptera, for example, Liposcelis spp.; from the order Anoplura, for example, Haematopinus spp., Linognathus spp., Pediculus spp., Pemphigus spp. and Phylloxera spp.; from the order Mallophaga, for example, Damalinea spp. and Trichodectes spp.; from the order Thysanoptera, for example, Frankliniella spp., Hercinothrips spp., Taeniothrips spp., Thrips palmi, Thrips tabaci and Scirtothrips aurantii; from the order Heteroptera, for example, Dichelops melacanthus, Distantiella theobroma, Dysdercus spp., Euchistus spp., Eurygaster spp., Leptocorisa spp., Nezara spp., Piesma spp., Rhodnius spp., Sahlbergella singularis, Scotinophara spp. and Triatoma spp.; from the order Homoptera, for example, Aleurothrixus floccosus, Aleyrodes brassicae, Aonidiella spp., Aphididae, Aphis spp., Aspidiotus spp., Bemisia tabaci, Ceroplaster spp., Chrysomphalus aonidium, Chrysomphalus dictyospermi, Coccus hesperidum, Empoasca spp., Eriosoma larigerum, Erythroneura spp., Gascardia spp., Laodelphax spp., Lecanium comi, Lepidosaphes spp., Macrosiphus spp., Myzus spp., Nephotettix spp., Nilaparvata spp., Paratoria spp., Pemphigus spp., Planococcus spp., Pseudaulacaspis spp., Pseudococcus spp., Psylla spp., Pulvinaria aethiopica, Quadraspidiotus spp., Rhopalosiphum spp., Saissetia spp., Scaphoideus spp., Schizaphis spp., Sitobion spp., Trialeurodes vaporariorum, Trioza erytreae and Unaspis citri; from the order Hymenoptera, for example, Acromyrmex, Athalia rosae, Atta spp., Cephus spp., Diprion spp., Diprionidae, Gilpinia polytoma, Hoplocampa spp., Lasius spp., Monomorium pharaonis, Neodiprion spp., Solenopsis spp. and Vespa spp.; from the order Diptera, for example, Antherigona soccata, Bibio hortulanus, Ceratitis spp., Chrysomyia spp., Culex spp., Cuterebra spp., Dacus spp., Delia spp., Drosophila melanogaster, Liriomyza spp., Melanagromyza spp., Orseolia spp., Oscinella frit, Pegomyia hyoscyami, Phorbia spp., Rhagoletis pomonella, Sciara spp.; from the order Acarina, for example, Acarus siro, Aceria sheldoni, Aculus schlechtendali, Amblyomma spp., Argas spp., Brevipalpus spp., Bryobia praetiosa, Calipitrimerus spp., Chorioptes spp., Dermanyssus gallinae, Eotetranychus carpini, Eriophyes spp., Hyalomma spp., Olygonychus pratensis, Omithodoros spp., Panonychus spp., Phyllocoptruta oleivora, Polyphagotarsonemus latus, Psoroptes spp., Rhipicephalus spp., Rhizoglyphus spp., Sarcoptes spp., Tarsonemus spp. and Tetranychus spp.; and from the class Nematoda, for example, the species of Meloidogyne spp. (for example, Meloidogyne incoginita and Meloidogyne javanica), Heterodera spp. (for example, Heterodera glycines, Heterodera schachtii, Heterodora avenae and Heterodora trifolii), Globodera spp. (for example, Globodera rostochiensis), Radopholus spp. (for example, Radopholus similes), Rotylenchulus spp., Pratylenchus spp. (for example, Pratylenchus neglectans and Pratylenchus penetrans), Aphelenchoides spp., Helicotylenchus spp., Hoplolaimus spp., Paratrichodorus spp., Longidorus spp., Nacobbus spp., Subanguina spp. Belonlaimus spp., Criconemella spp., Criconemoides spp. Ditylenchus spp., Dolichodorus spp., Hemicriconemoides spp., Hemicycliophora spp., Hirschmaniella spp., Hypsoperine spp., Macroposthonia spp., Melinius spp., Punctodera spp., Quinisulcius spp., Scutellonema spp., Xiphinema spp., and Tylenchorhynchus spp.

The formulations reported herein can be designed for a particular use. Preferably, the formulation is designed for protecting cultivated plants or their propagation materials. Accordingly, a formulation can be applied to the plant in a conventional manner, such as a foliar spray using ground or aerial application where permitted. Advantageously, the formulations are designed for field applications for controlling or preventing damage by pests and/or undesirable plant species, which are found in agriculture and forestry, and can particularly damage the plant or hinder its growth in the early stages of its development.

Methods of applying formulations to the soil can be via any suitable method, particularly one that ensures that the combination penetrates the soil. For example, nursery tray application, in furrow application, soil drenching, soil injection, drip irrigation, application through sprinklers or central pivot, incorporation into soil (broad cast or in band) are some examples of such methods.

The term “plant propagation material” is understood to denote all of the generative parts of the plant. These include, for example, seeds, vegetative plant material such as cuttings and tubers (for example, potatoes), roots, fruits, bulbs, rhizomes, and other parts of plants. Germinated plants and young plants, which are to be transplanted after germination or after emergence from the soil, may also be treated. These young plants may be protected before transplantation by a total or partial treatment by immersion. Plants and plant parts grown hydroponically are also included in this definition

Methods for applying formulations taught herein to plant propagation material, especially seeds, includes but is not limited to dressing, coating, pelleting and soaking application methods of the propagation material.

The formulation can be applied to the seeds using conventional treating techniques and machines. These include for example, fluidized bed techniques, the roller mill method, rotostatic seed treaters, drum coaters, and spouted beds. The seeds may be sized before or after coating.

Application of the formulations described herein onto plant propagation material also includes protecting the plant propagation material treated with the formulation of the present invention by placing one or more formulation-containing particles next to a formulation-treated seed, wherein the amount of formulation is such that the formulation-treated seed and the formulation-containing particles together contain an effective dose of the formulation and the formulation dose contained in the formulation-treated seed is less than or equal to the maximum effective dose of the formulation. This may be accomplished with reference to WO 2005/120226, which is incorporated by reference herein.

Application of the formulation onto a seed can also include controlled release coatings on the seeds, wherein the active formulation is incorporated into materials that release the active compounds over time. Examples of controlled release seed treatment technologies include polymer films, waxes, or other seed coatings. The formulation may be incorporated into the controlled release material or applied between layers of materials, or both.

The formulations taught herein may be suitable for one or more different plants. These plants include, for example, but are not limited to cereals (wheat, barley, rye, oats, corn, sweet corn, rice, sorghum, triticale, forage and turf grasses and related crops); beet (sugar beet and fodder beet, beet root); leguminous plants (beans, including pinto, navy, lima and other edible beans, lentils, peas, chickpeas, soybeans, alfalfa, clover, peanuts); oil plants (rape, mustard, sunflowers, canola); cucurbits (marrows, cucumbers, pumpkins, melons, gourds, zucchini); fibre plants (cotton, flax, hemp, jute); vegetables (spinach, lettuce, endive, cress, corn salad, asparagus, cabbages, cauliflower, brussels sprout, broccoli, Kale, Rapini, Bok choy, Kai-lan, Komatsuna, Mizuna greens, celeriac celery, leeks, carrots, onions, tomatoes, peppers (bell and chili) potatoes (meaning, in this case and in others like sweet potatoes, the “seed” tubers used to plant a crop, as well as true seed as used in breeding and propagation), paprika, radishes, duckweed, egg plants); as well as tobacco, all fruit and nut crops and hydroponically grown plants, plus ornamentals (flowers, shrubs, broad-leaved trees and evergreens, such as conifers) and herbs (basil, oregano, parsley, thyme).

Suitable target crops also include transgenic crop plants of the foregoing types. The transgenic crop plants used according to the invention are plants, or propagation material thereof, which are transformed by recombinant DNA technology, or the progeny of plants transformed by recombinant DNA. They may be capable, for example, of synthesizing selectively acting toxins, or capable of expressing a herbicidal or fungicidal resistance. Examples of such toxins, or transgenic plants which are capable of synthesizing such toxins, have been disclosed, for example, in EP-A-0 374 753, WO 93/07278, WO 95/34656, EP-A-0 427 529 and EP-A-451 878 and are incorporated by reference in the present application.

Plant propagation material treated by a formulation taught herein may be naturally, or genetically engineered to be, resistant to pest damage; accordingly, the present invention also provides a pathogenic and/or pest resistant plant propagation material which is treated with the combination and consequently at least the active ingredients thereof are adhered on the propagation material, such as seed.

When the formulation presented herein includes glyphosate, use is contemplated with glyphospate tolerant plants for control of species that are not glyphosate tolerant. One embodiment provides a method comprising (a) applying a glyphosate-containing formulation as described herein to a glyphosate tolerant plant and its surroundings after emergence.

Glyphosate-containing formulations should be applied according to the label instructions for the material in the geographical area in which it is to be applied. Two common glyphosate formulations are Roundup™ and TOUCHDOWN® and the U.S. labels for these products are incorporated herein by reference.

When the formulation presented herein includes imidacloprid, use is contemplated with plants for control of many sucking insects such as aphids. One embodiment provides a method comprising (a) applying an imidacloprid-containing formulation as described herein to a plant (i) before emergence, (ii) after emergence, or (iii) both (i) and (ii).

Imidacloprid-containing formulations should be applied according to the label instructions for the material in the geographical area in which it is to be applied. Of many imidacloprid formulations, examples are ADMIRE®, Confidorm, GAUCHO® and PROVADO®. The U.S. labels for these products are incorporated herein by reference.

Formulations may also comprise alkali metal, alkaline earth metal, metal, or ammonium salts. Zinc chloride and alkali metal, alkaline earth metal, or ammonium salts of mineral acids, especially nitrates, phosphates, sulfates, chlorides, and carbonates of sodium, potassium, ammonium, magnesium, and calcium are preferred.

Formulations taught herein of the present invention may additionally comprise micronutrients to aid in the nourishment and health of the plant and/or plant propagation material. Suitable micronutrients include, but are not limited to, chlorine (Cl), zinc (ZN), boron (B), copper (Cu), iron (Fe), manganese (Mn) or molybdenum (Mo). Micronutrients may be supplied in chelate form.

It should be noted that formulations as reported herein may be designed to exclude certain components, including but not limited to fungicides and/or fertilizers.

Formulations described herein may include one or more additives in addition to GABA and pesticides. Such additives include, but are not limited to, uv-protectants, pigments, dyes, extenders such as flour, dispersing agents, excipients, anti-freezing agents, preservatives, herbicidal safeners, seed safeners, seed conditioners, micronutients, fertilizers, biocontrol agents, surfactants, sequestering agents, plasticizers, colorants, brighteners, emulsifiers, flow agents such as calcium stearate, talc and vermiculite, coalescing agents, defoaming agents, humectants, thickeners, waxes, bactericides, insecticides, pesticides, and fillers such as cellulose, glass fibers, clay, kaolin, talc, pulverized tree bark (e.g., Douglas fir bark or alderbark), calcium carbonate and wood meal, and odor-modifying agents. Typical excipients include finely divided mineral substances such as pumice, attapulgite, bentonite, kaoline zeolite, diatomite, and other clays, modified diatomaceous adsorbents, charcoal, vermiculite, finely divided organic substances such as peat moss, wood powder, and the like. Such additives are commercially available.

One or more active ingredients and/or additives may be included in the formulation in encapsulated form or microencapsulated or nanoencapsulated form. The ingredients and/or additives may be encapsulated alone, separately, or in individual groups. Encapsulation strategy may depend on the release profile sought for the materials.

The weight ratio of active ingredient compounds is selected as to give the desired, for example synergistic, action. In general, the weight ratio would vary depending on the specific active ingredient and how many active ingredients are present in the formulation. If the formulation includes three active ingredients the weight ratio between any two ingredients, independently of each other, is from 100:1 to 1:100, including from 99:1, 98:2, 97:3, 96:4, 95:5, 94:6, 93:7, 92:8, 91:9, 90:10, 89:11, 88:12, 87:13, 86:14, 85:15, 84:16, 83:17, 82:18, 81:19, 80:20, 79:21, 78:22, 77:23, 76:24, 75:25, 74:26, 73:27, 72:28, 71:29, 70:30, 69:31, 68:32, 67:33, 66:34, 65:45, 64:46, 63:47, 62:48, 61:49, 60:40, 59:41, 58:42, 57:43, 56:44, 55:45, 54:46, 53:47, 52:48, 51:49, 50:50, 49:51, 48:52, 47:53, 46:54, 45:55, 44:56, 43:57, 42:58, 41:59, 40:60, 39:61, 38:62, 37:63, 36:64, 35:65, 34:66, 33:67, 32:68, 31:69, 30:70, 29:71, 28:72, 27:73, 26:74, 25:75, 24:76, 23:77, 22:78, 21:79, 20:80, 19:81, 18:82, 17:83, 16:84, 15:85, 14:86, 13:87, 12:88, 11:89, 10:90, 9:91, 8:92, 7:93, 6:94, 5:95, 4:96, 3:97, 2:98, to 1:99. Preferred weight ratios between any two ingredients are preferably from 75:1 to 1:75, more preferably, 50:1 to 1.50, especially 25:1 to 1:25, advantageously 10:1 to 1:10, such as 5:1 to 1:5.

The rates of application (use) of the formulation vary, for example, according to type of use, type of crop, the specific active ingredients in the formulation, type of plant propagation material (if appropriate), but is such that the active ingredients in the formulation are of an effective amount to provide the desired enhanced action (such as weed or insect control) and can be determined by trials.

Formulation components may be used either in pure form, i.e., as a solid active ingredient, for example, in a specific particle size, or preferably together with at least one additive customary in formulation technology, such as extenders, e.g., solvents or solid carriers, or surface-active compounds (surfactants).

If the formulation components are applied simultaneously, they can be obtained from a separate formulation source and mixed together (known as a tank-mix, ready-to-apply, spray broth, or slurry), optionally with other pesticides, or they can be obtained as single source (known as a pre-mix, concentrate, formulated compound (or product)), and optionally mixed together with other pesticides.

Examples of foliar application types for pre-mix compositions include: granules, wettable powders, water dispersible granules (powders), water soluble granules, soluble concentrates, emulsifiable concentrate, emulsions, oil in water, micro-emulsion, aqueous suspension concentrate, aqueous capsule suspension, oil-based suspension concentrate, aqueous suspo-emulsion and slow release preparations based on microencapsulation and nanoencapsulation techniques.

Examples of seed treatment formulation types for pre-mix compositions include: wettable powders for seed treatment slurry, solution for seed treatment, emulsions for seed treatment, suspension concentrate for seed treatment, water dispersible granules, and aqueous capsule suspension. Formulation types suitable for tank-mix compositions include, for example, solutions, dilute emulsions, suspensions, or a mixture thereof, and dusts.

As with the nature of the formulations, the methods of application, such as foliar, drench, spraying, atomizing, dusting, scattering, coating or pouring, are chosen in accordance with the intended objectives and the prevailing circumstances.

The tank-mix compositions are generally prepared by diluting with a solvent (for example, water) the one or more pre-mix compositions containing different pesticides, and optionally further auxiliaries. Suitable carriers and adjuvants can be solid or liquid and are the substances ordinarily employed in formulation technology, e.g., natural or regenerated mineral substances, solvents, dispersants, wetting agents, tackifiers, thickeners, binders or fertilizers.

Formulations may be prepared, for example, by homogeneously mixing and/or grinding the active ingredients with extenders, e.g., solvents, solid carriers and, where appropriate, surface-active compounds (surfactants).

Suitable solvents include, for example, aromatic hydrocarbons, preferably the fractions containing 8 to 12 carbon atoms, e.g. xylene mixtures or substituted naphthalenes, phthalates, such as dibutyl phthalate or dioctyl phthalate, aliphatic hydrocarbons, such as cyclohexane or paraffins, alcohols and glycols and their ethers and esters, such as ethanol, ethylene glycol, ethylene glycol monomethyl or monoethyl ether, ketones, such as cyclohexanone, strongly polar solvents, such as N-methyl-2-pyrrolidone, dimethyl sulfoxide or dimethylformamide, as well as vegetable oils or epoxidized vegetable oils, such as epoxidized coconut oil or soybean oil; or water.

The solid carriers used, e.g., for dusts and dispersible powders, are normally natural mineral fillers, such as calcite, talcum, kaolin, montmorillonite or attapulgite. To improve the physical properties it is also possible to add highly dispersed silicic acid or highly dispersed absorbent polymers. Suitable granulated adsorptive carriers are porous types, for example pumice, broken brick, sepiolite or bentonite, and suitable nonsorbent carriers are, for example, calcite or sand. In addition, a great number of pregranulated materials of inorganic or organic nature can be used, e.g., especially dolomite or pulverized plant residues.

Depending upon the nature of the active ingredient compounds to be formulated, suitable surface-active compounds are non-ionic, cationic and/or anionic surfactants having good emulsifying, dispersing and wetting properties. The term “surfactants” will also be understood as comprising mixtures of surfactants.

Particularly advantageous application-promoting adjuvants are also natural or synthetic phospholipids of the cephalin and lecithin series, e.g., phosphatidylethanolamine, phosphatidylserine, phosphatidylglycerol and lysolecithin.

Generally, a tank-mix for foliar or soil application comprises 0.1 to 20%, especially 0.1 to 15%, active ingredient compounds, and 99.9 to 80%, especially 99.9 to 85%, of a solid or liquid additives (including, for example, a solvent such as water), where the additives can be a surfactant in an amount of 0 to 20%, especially 0.1 to 15%, based on the tank-mix formulation.

Typically, a pre-mix formulation for foliar application comprises 0.1 to 99.9%, especially 1 to 95%, active ingredient compounds, and 99.9 to 0.1%, especially 99 to 5%, of a solid or liquid additives (including, for example, a solvent such as water), where the additives can be a surfactant in an amount of 0 to 50%, especially 0.5 to 40%, based on the pre-mix formulation.

Normally, a tank-mix formulation for seed treatment application comprises 0.25 to 80%, especially 1 to 75%, active ingredient compounds, and 99.75 to 20%, especially 99 to 25%, of solid or liquid additives (including, for example, a solvent such as water), where the additives can be a surfactant in an amount of 0 to 40%, especially 0.5 to 30%, based on the tank-mix formulation.

Typically, a pre-mix for seed treatment application comprises 0.5 to 99.9%, especially 1 to 95%, active ingredient compounds, and 99.5 to 0.1%, especially 99 to 5%, of solid or liquid additive (including, for example, a solvent such as water), where the additives can be a surfactant in an amount of 0 to 50%, especially 0.5 to 40%, based on the pre-mix formulation.

Whereas commercial products will preferably be made as concentrates (e.g., pre-mix composition), the end user will normally employ dilute mixtures (e.g., tank mix composition).

Preferred seed treatment pre-mixes formulations are aqueous suspension concentrates. The formulation can be applied to the seeds using conventional treating techniques and machines, such as fluidized bed techniques, the roller mill method, rotostatic seed treaters, and drum coaters. Other methods, such as spouted beds may also be useful. The seeds may be presized before coating. After coating, the seeds are typically dried and then transferred to a sizing machine for sizing. Such procedures are known in the art.

Using such formulations either straight or diluted, plant propagation material can be treated and protected against damage, for example, from pathogen(s), by spraying, pouring or immersing. The active ingredient combinations according to the invention are distinguished by the fact that they are especially well tolerated by plants and are environmentally friendly.

In a further preferred embodiment, an effective amount of inventive formulation as described herein is applied to a plant or plant part to reduce stress and/or ameliorate anticipated stress. This allows the reduction of undesirable effects that may be caused either by the pesticide used in the formulation or by a separate pesticide already present or expected to be present in the plant's environment or plant part's anticipated environment. This reduction in undesirable effects occurs while still allowing the pesticide to be effective against its intended target(s). Without limiting the accepted definitions of “effective amount,” the applicant notes that an “effective amount” of a composition is an amount that has been found useful to achieve a desired result, whether that desired result is, for example, elimination of some or all of a pest, or alleviation of some or all of the stress affecting a plant.

Amelioration of plant stress may be evaluated, for example by a number of methods. For example, the decrease in the yield drag may be measured by comparing yield obtained with yield anticipated. Decreased stress may also be evaluated by examining and/or quantifying improvement in growth of the desired plants.

Improved growth may be shown, for example, by enhanced yield or vigor of the desired plant. Enhanced yield may be examined by reviewing the yield that is expected in the absence of the novel formulations of the invention, and comparing it to the yield that is achieved. Yield may be based on such items as quantity, weight, or volume of product, as may be appropriate for a given agricultural product. Enhanced vigor may be shown, for example, by enhanced height, biomass (shoots and/or roots), color, canopy, or maturity of treated plants. Visible phytotoxic reactions and symptoms such as chlorosis, necrosis, growth distortions and stunting can be quantified on a rating scale or by counts of the number or percent of affected plants. If phytotoxic effects are transitory, the time for a plant to overcome them can also be measured. Germination effects can be evaluated by counts and recording emergence times.

### EXAMPLES

The teachings and embodiments as included herein are better illustrated by the examples presented below:

### Prophetic Example 1

Imidacloprid is known to induce phytotoxicity in greenhouse-grown tomato and cucumber plants. Ebel et al, 2000 report that at rates 5, 10, 20, 30, and 40 mg a.i. per 4.5-inch (550-mL) pot, both species developed phytotoxicity symptoms of leaf chlorosis of the oldest leaves and distorted growth and marginal necrosis of newer leaves within 1 week after application. By the end of the experiment, even the lowest rate caused phytotoxicity symptoms. The symptoms were associated with major differences in plant nutrition as evidenced by assessments of plant nutrient levels in the test and control plants. These data indicate that imidacloprid can significantly alter plant nutrition.

In this prophetic example, a formulation including 500 ppm AUXIGRO® formulation and 300 ppm imidacloprid is applied to greenhouse-grown mature tomato plants at a rate of 60 mls/plant for aphis or whitefly control. The maintenance of a healthy nutrient balance and the relief of stress attributable to the action of AUXIGRO® formulation reduces the onset and intensity of the phytotoxicity symptoms set forth above.

### Prophetic Example 2

In Prophetic Example 2, a tank-mix combination of glyphosate and of the GABA formulation AUXIGRO® is applied to field-grown, glyphosate-tolerant soybeans in such a way as to apply 1.5 quarts of Roundup and 4 oz. AUXIGRO® formulation per acre respectively. The stress relief action of the AUXIGRO® components will reduce or eliminate the 3-5% yield drag expected from an application of glyphosate without the presence of GABA and glutamic acid.

Patents, patent applications, publications, scientific articles, books, web sites, and other documents and materials referenced or mentioned herein are indicative of the levels of skill of those skilled in the art to which the inventions pertain, as of the date each publication was written, and all are incorporated by reference as if fully rewritten herein. Inclusion of a document in this specification is not an admission that the document represents prior invention or is prior art for any purpose. To the extent that the incorporated material conflicts with existing definitions, statements, or other disclosure material set forth in this description, the disclosure as explicitly set forth herein supersedes any conflicting material incorporated by reference.

Whereas particular embodiments of this invention have been described for purposes of illustration, it will be evident to those persons skilled in the art that numerous variations of the details of the present teaching may be made without departing from the invention as defined in the appended claims.

I claim:

1. A formulation comprising gamma-aminobutyric acid and at least one pesticide selected from the group consisting of an insecticide, an acaracide, a nematicide, a molluscicide and a herbicide.

2. The formulation of claim 1, wherein said pesticide is selected from the group consisting of an insecticide, acaracide, nematicide, and molluscicide.

3. The formulation of claim 2, wherein said insecticide, acaracide, nematicide, or molluscicide is selected from the group consisting of abamectin; acephate; acetamiprid, acrinathhn; alanycarb; aldicarb, alpha-cypermethrin; alphamethrin; amitraz; azinphos A; azinphos-methyl; azocyclotin; bendiocarb; benfuracarb; bensultap; beta cyfluthrin; bifenthrin; brofenprox; bromophos A; bufencarb; buprofezin; butocarboxin; butylpyridaben; cadusafos; carbaryl; carbofuran; carbophenothion; carbosulfan; carboxin; cartap; chloethocarb; chloranthraniliprole; chloroethoxyfos; chlorfenvenphos; chlorofluazuron; chloromephos; chlorpyrifos; cis-res-methrin; clocythrin; clofentezin; clothianidin; cyanoimine; cyanophos; cycloprothhn; cyfluthrin; cyhexatin; deltamethrin; demeton M; demeton S; demeton-S-methyl; diafenthiuron; dibutylaminothio; dichlofenthion; dicliphos; diethion; diflubenzuron; dimethoate; dimethylvinphos; dinotefuran; dioxathion; doramectin; edifenphos; emamectin; endosulfan; esfenvalerate; ethiofencarb; ethion; ethiprole; ethofenprox; ethoprophos; etrimphos; fenamiphos; fenazaquin; fenbutatin oxide; fenitrothion; fenobucarb; fenothiocarb; fenoxycarb; fenpropathrin; fenpyrad; fenpyroximate; fenthion; fenvalerate; fipronil; fluazinam; flubendiamide; flucycloxuron; flucythrinate; flufenoxuron; flufenprox; fluxofenime; fonophos; formothion; fosthiazate; fubfenprox; gamma cyhalothrin; HCH; heptenophos; hexaflumuron; hexythiazox; imidacloprid; iprobenfos; isoprocarb; isoxathion; ivermectin, lambda cyhalothrin; lindane; lufenuron; malathion; mecarbam; mesulfenphos; metaldehyde; methamidophos; methiocarb; methomyl; metolcarb; mevinphos; milbemectin; milbemycin oxime; moxidectin; naled; NC 184; nitenpyram; nitromethylene; omethoate; oxamyl; oxydemethon M; oxydeprofos; parathion; parathion-methyl; permethrin; phenthoate; phorate; phosalone; phosmet; phoxim; pirimicarb; pirimiphos A; pirimiphos M; promecarb; profenofos; propaphos; propargite; propoxur; prothiofos; prothoate; pymetrozine; pyrachlophos; pyrada-phenthion; pyresmethrin; pyrethrum; pyridaben; pyrimidifen; pyripfoxyfen; pyriproxyfen; rynaxypyr; salithion; sebufos; silafluofen; spinosad; sulfotep; sulprofos; tebufenozide; tebufenpyrad; tebupihmphos; teflubenzuron; tefluthrin; temephos; terbam; terbufos; tetrachloro-vinphos; thiacloprid; thiafenox; thiamethoxam; thiodicarb; thiofanox; thionazin; thuringiensin; tralomethrin; triarthen; triazamate; triazophos; triazuron; trichlorofon; triflumuron; trimethacarb; vamidothion; xylylcarb; zeta-cypermethrin; zetamethrin; and Bacillus thuringiensis (Bt) products, including the salts and esters thereof.

4. The formulation of claim 1, wherein said pesticide is a herbicide.

5. The formulation of claim 4, wherein said herbicide is selected from the group consisting of amide herbicides, including allidochlor, amicarbazone, beflubutamid, benzadox, benzipram, bromobutide, cafenstrole, CDEA, cyprazole, dimethenamid, dimethenamid-P, diphenamid, epronaz, etnipromid, fentrazamide, flucarbazone, flupoxam, fomesafen, halosafen, isocarbamid, isoxaben, napropamide, naptalam, pethoxamid, propyzamide, quinonamid, saflufenacil, and tebutam; anilide herbicides, including chloranocryl, cisanilide, clomeprop, cypromid, diflufenican, etobenzanid, fenasulam, flufenacet, flufenican, ipfencarbazone, mefenacet mefluidide, metamifop, monalide, naproanilide, pentanochlor, picolinafen, propanil, sulfentrazone; arylalanine herbicides, including benzoylprop, flamprop, and flamprop-M; chloroacetanilide herbicides, including acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, and xylachlor; sulfonanilide herbicides, including benzofluor, cloransulam, diclosulam, florasulam, flumetsulam, metosulam, perfluidone, pyrimisulfan, and profluazol; sulfonamide herbicides, including asulam, carbasulam, fenasulam, oryzalin, penoxsulam, and pyroxsulam; thioamide herbicides, including bencarbazone and chlorthiamid; antibiotic herbicides, including bilanafos; aromatic acid herbicides; benzoic acid herbicides, including chloramben, dicamba, 2,3,6-TBA, and tricamba; pyrimidinyloxybenzoic acid herbicides, including bispyribac, and pyriminobac; pyrimidinylthiobenzoic acid herbicides, including pyrithiobac; phthalic acid herbicides, including chlorthal, picolinic acid herbicides, aminopyralid, clopyralid, and picloram; quinolinecarboxylic acid herbicides, including quinclorac, and quinmerac; arsenical herbicides, including cacodylic acid, CMA, DSMA, hexaflurate, MAA, MAMA, MSMA, potassium arsenite, and sodium arsenite; benzoylcyclohexanedione herbicides, including mesotrione, sulcotrione, tefuryltrione, and tembotrione; benzofuranyl alkylsulfonate herbicides, including benfuresate, and ethofumesate; benzothiazole herbicides, including benazolin, benzthiazuron, fenthiaprop, mefenacet, and methabenzthiazuron; carbamate herbicides, including asulam, carboxazole, chlorprocarb, dichlormate, fenasulam, karbutilate, and terbucarb; carbanilate herbicides, including barban, BCPC, carbasulam, carbetamide, CEPC, chlorbufam, chlorpropham, CPPC, desmedipham, phenisopham, phenmedipham, phenmedipham-ethyl, propham, and swep; cyclohexene oxime herbicides, including alloxydim, butroxydim, clethodim, cloproxydim, cycloxydim, profoxydim, sethoxydim, tepraloxydim, and tralkoxydim; cyclopropylisoxazole herbicides, including isoxachlortole, and isoxaflutole; dicarboximide herbicides, including cinidon-ethyl, flumezin, flumiclorac, flumioxazin, and flumipropyn; dinitroaniline herbicides, including benfluralin, butralin, dinitramine, ethalfluralin, fluchloralin, isopropalin, methalpropalin, nitralin, oryzalin, pendimethalin, prodiamine, profluralin, and trifluralin; dinitrophenol herbicides, including dinofenate, dinoprop, dinosam, dinoseb, dinoterb, DNOC, etinofen, and medinoterb; diphenyl ether herbicides, including ethoxyfen, nitrophenyl ether herbicides, including acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen, oxyfluorfen, dithiocarbamate herbicides, including dazomet, and metam; halogenated aliphatic herbicides, including alorac, chloropon, dalapon, flupropanate, hexachloroacetone, iodomethane, methyl bromide, monochloroacetic acid, SMA, and TCA; imidazolinone herbicides, including imazamethabenz, imazamox, imazapic, imazapyr, imazaquin, and imazethapyr; inorganic herbicides, including ammonium sulfamate, borax, calcium chlorate, copper sulfate ferrous sulfate, potassium azide, potassium cyanate, sodium azide, sodium chlorate, and sulfuric acid; nitrile herbicides, including bromobonil, bromoxynil, chloroxynil, dichlobenil, iodobonil, ioxynil, and pyraclonil; organophosphorus herbicides, including amiprofos-methyl, anilofos, bensulide, bilanafos, butamifos, 2,4-DEP, DMPA, EBEP, fosamine, glufosinate, glufosinate-P, glyphosate, and piperophos; oxadiazolone herbicides, including dimefuron, methazole, oxadiargyl, and oxadiazon; oxazole herbicides, including carboxazole, isouron, isoxaben, isoxachlortole, isoxaflutole, monisouron, pyroxasulfone, and topramezone; phenoxy herbicides, including bromofenoxim, clomeprop, 2,4-DEB, 2,4-DEP, difenopenten, disul, erbon, etnipromid, fenteracol, and trifopsime; phenoxyacetic herbicides, including 4-CPA, 2,4-D, 3,4-DA, MCPA, MCPA-thioethyl, and 2,4,5-T; phenoxybutyric herbicides, including 4-CPB, 2,4-DB, 3,4-DB, MCPB, and 2,4,5-TB; phenoxypropionic herbicides, including cloprop, 4-CPP, dichlorprop, dichlorprop-P, 3,4-DP, fenoprop, mecoprop, and mecoprop-P; aryloxyphenoxypropionic herbicides, including chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, and trifop; phenylenediamine herbicides, including dinitramine, and prodiamine; pyrazole herbicides, including azimsulfuron, difenzoquat, halosulfuron, metazachlor, pyrazosulfuron, and pyroxasulfone; benzoylpyrazole herbicides, including benzofenap, pyrasulfotole, pyrazolynate, pyrazoxyfen, and topramezone; phenylpyrazole herbicides, including fluazolate, nipyraclofen, and pyraflufen; pyridazine herbicides, including credazine, pyridafol, and pyridate; pyridazinone herbicides, including brompyrazon, chloridazon, dimidazon, flufenpyr, metflurazon, norflurazon, oxapyrazon, and pydanon; pyridine herbicides, including aminopyralid, cliodinate, clopyralid, diflufenican, dithiopyr, flufenican, fluroxypyr, haloxydine, picloram, picolinafen, pyriclor, pyroxsulam, thiazopyr, and triclopyr; pyrimidinediamine herbicides, including iprymidam, and tioclorim; quaternary ammonium herbicides, including cyperquat, diethamquat, difenzoquat, diquat, morfamquat, and paraquat; thiocarbamate herbicides, including butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, and vernolate; thiocarbonate herbicides, including dimexano, EXD, and proxan; thiourea herbicides, including methiuron; triazine herbicides, including dipropetryn, triaziflam, and trihydroxytriazine; chlorotriazine herbicides, including atrazine, chlorazine, cyanazine, cyprazine, eglinazine, ipazine, mesoprazine, procyazine, proglinazine, propazine, sebuthylazine, simazine, terbuthylazine, and trietazine; methoxytriazine herbicides, including atraton, methometon, prometon, secbumeton, simeton, and terbumeton; methylthiotriazine herbicides, includingametryn, aziprotryne, cyanatryn, desmetryn, dimethametryn, methoprotryne, prometryn, simetryn, terbutryn, triazinone herbicides, including ametridione, amibuzin, hexazinone, isomethiozin, metamitron, metribuzin, triazole herbicides, including amitrole, cafenstrole, epronaz, and flupoxam; triazolone herbicides, including amicarbazone, bencarbazone, carfentrazone, flucarbazone, ipfencarbazone, propoxycarbazone, sulfentrazone, and thiencarbazone; triazolopyrimidine herbicides, including cloransulam, diclosulam, florasulam, flumetsulam, metosulam, penoxsulam, pyroxsulam, uracil herbicides, including benzfendizone, bromacil, butafenacil, flupropacil, isocil, lenacil, saflufenacil, and terbacil; urea herbicides, including benzthiazuron, cumyluron, cycluron, dichloralurea, diflufenzopyr, isonoruron, isouron, methabenzthiazuron, monisouron, and noruron; phenylurea herbicides, including anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, and thidiazuron; sulfonylurea herbicides; pyrimidinylsulfonylurea herbicides, including amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron, and trifloxysulfuron; triazinylsulfonylurea herbicides, including chlorsulfuron, cinosulfuron, ethametsulfuron, iodosulfuron, metsulfuron, prosulfuron, thifensulfuron, triasulfuron, tribenuron, triflusulfuron, and tritosulfuron; thiadiazolylurea herbicides, including buthiuron, ethidimuron, tebuthiuron, thiazafluron, and thidiazuron; and unclassified herbicides, including acrolein, allyl alcohol, aminocyclopyrachlor, azafenidin, bentazone, benzobicyclon, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, endothal, fluoromidine, fluridone, flurochloridone,flurtamone, fluthiacet, indanofan, methyl isothiocyanate, OCH, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan, and tritac.

6. The formulation of claim 4, wherein said herbicide is glyphosate.

7. The formulation of claim 6, wherein said glyphosate is a glyphosate salt selected from the diammonium salt of glyphosate, the isopropylamine salt of glyphosate, and the trimethylsulfonium salt of glyphosate.

8. The formulation of claim 1, comprising gamma-aminobutyrate, at least one herbicide, and at least one member of the group consisting of an insecticide, an acaracide, a nematicide, and a molluscicide.

9. The formulation of claim 1, further comprising a source of proteinaceous amino acids.

10. The formulation of claim 1, further comprising an effective amount of glutamic acid.

11. The formulation of claim 2, wherein said pesticide is imidacloprid.

12. A method of controlling pest damage in a plant comprising applying an effective amount of the formulation of claim 1 on the plant, on part of the plant, or in the plant's surroundings.

13. A method of controlling growth of undesirable plants in the vicinity of a desirable plant, comprising applying an effective amount of the formulation of claim 1 on the desirable plant, on the undesirable plant, on part of the desirable plant, in the desirable plant's surroundings, or in the undesirable plant's surroundings.

14. A method of alleviating at least one of stress and phytotoxic symptoms in a plant, comprising applying an effective amount of the formulation of claim 1 on a plant in need of at least one of stress alleviation and alleviation of phytotoxic symptoms.

15. The method of claim 14, wherein said pesticide is selected from the group consisting of an insecticide, acaracide, nematicide, and molluscicide.

16. The method of claim 15, wherein said insecticide, acaracide, nematicide, or molluscicide is selected from the group consisting of abamectin; acephate; acetamiprid, acrinathhn; alanycarb; aldicarb, alpha-cypermethrin; alphamethrin; amitraz; azinphos A; azinphos-methyl; azocyclotin; bendiocarb; benfuracarb; bensultap; beta cyfluthrin; bifenthrin; brofenprox; bromophos A; bufencarb; buprofezin; butocarboxin; butylpyridaben; cadusafos; carbaryl; carbofuran; carbophenothion; carbosulfan; carboxin; cartap; chloethocarb; chloranthraniliprole; chloroethoxyfos; chlorfenvenphos; chlorofluazuron; chloromephos; chlorpyrifos; cis-res-methrin; clocythrin; clofentezin; clothianidin; cyanoimine; cyanophos; cycloprothhn; cyfluthrin; cyhexatin; deltamethrin; demeton M; demeton S; demeton-S-methyl; diafenthiuron; dibutylaminothio; dichlofenthion; dicliphos; diethion; diflubenzuron; dimethoate; dimethylvinphos; dinotefuran; dioxathion; doramectin; edifenphos; emamectin; endosulfan; esfenvalerate; ethiofencarb; ethion; ethiprole; ethofenprox; ethoprophos; etrimphos; fenamiphos; fenazaquin; fenbutatin oxide; fenitrothion; fenobucarb; fenothiocarb; fenoxycarb; fenpropathrin; fenpyrad; fenpyroximate; fenthion; fenvalerate; fipronil; fluazinam; flubendiamide; flucycloxuron; flucythrinate; flufenoxuron; flufenprox; fluxofenime; fonophos; formothion; fosthiazate; fubfenprox; gamma cyhalothrin; HCH; heptenophos; hexaflumuron; hexythiazox; imidacloprid; iprobenfos; isoprocarb; isoxathion; ivermectin, lambda cyhalothrin; lindane; lufenuron; malathion; mecarbam; mesulfenphos; metaldehyde; methamidophos; methiocarb; methomyl; metolcarb; mevinphos; milbemectin; milbemycin oxime; moxidectin; naled; NC 184; nitenpyram; nitromethylene; omethoate; oxamyl; oxydemethon M; oxydeprofos; parathion; parathion-methyl; permethrin; phenthoate; phorate; phosalone; phosmet; phoxim; pirimicarb; pirimiphos A; pirimiphos M; promecarb; profenofos; propaphos; propargite; propoxur; prothiofos; prothoate; pymetrozine; pyrachlophos; pyrada-phenthion; pyresmethrin; pyrethrum; pyridaben; pyrimidifen; pyripfoxyfen; pyriproxyfen; rynaxypyr; salithion; sebufos; silafluofen; spinosad; sulfotep; sulprofos; tebufenozide; tebufenpyrad; tebupihmphos; teflubenzuron; tefluthrin; temephos; terbam; terbufos; tetrachloro-vinphos; thiacloprid; thiafenox; thiamethoxam; thiodicarb; thiofanox; thionazin; thuringiensin; tralomethrin; triarthen; triazamate; triazophos; triazuron; trichlorofon; triflumuron; trimethacarb; vamidothion; xylylcarb; zeta-cypermethrin; zetamethrin; and Bacillus thuringiensis (Bt) products, including the salts and esters thereof.

17. The method of claim 14, wherein said pesticide is a herbicide.

18. The method of claim 17, wherein said herbicide is selected from the group consisting of amide herbicides, including allidochlor, amicarbazone, beflubutamid, benzadox, benzipram, bromobutide, cafenstrole, CDEA, cyprazole, dimethenamid, dimethenamid-P, diphenamid, epronaz, etnipromid, fentrazamide, flucarbazone, flupoxam, fomesafen, halosafen, isocarbamid, isoxaben, napropamide, naptalam, pethoxamid, propyzamide, quinonamid, saflufenacil, and tebutam; anilide herbicides, including chloranocryl, cisanilide, clomeprop, cypromid, diflufenican, etobenzanid, fenasulam, flufenacet, flufenican, ipfencarbazone, mefenacet mefluidide, metamifop, monalide, naproanilide, pentanochlor, picolinafen, propanil, sulfentrazone; arylalanine herbicides, including benzoylprop, flamprop, and flamprop-M; chloroacetanilide herbicides, including acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor, and xylachlor; sulfonanilide herbicides, including benzofluor, cloransulam, diclosulam, florasulam, flumetsulam, metosulam, perfluidone, pyrimisulfan, and profluazol; sulfonamide herbicides, including asulam, carbasulam, fenasulam, oryzalin, penoxsulam, and pyroxsulam; thioamide herbicides, including bencarbazone and chlorthiamid; antibiotic herbicides, including bilanafos; aromatic acid herbicides; benzoic acid herbicides, including chloramben, dicamba, 2,3,6-TBA, and tricamba; pyrimidinyloxybenzoic acid herbicides, including bispyribac, and pyriminobac; pyrimidinylthiobenzoic acid herbicides, including pyrithiobac; phthalic acid herbicides, including chlorthal, picolinic acid herbicides, aminopyralid, clopyralid, and picloram; quinolinecarboxylic acid herbicides, including quinclorac, and quinmerac; arsenical herbicides, including cacodylic acid, CMA, DSMA, hexaflurate, MAA, MAMA, MSMA, potassium arsenite, and sodium arsenite; benzoylcyclohexanedione herbicides, including mesotrione, sulcotrione, tefuryltrione, and tembotrione; benzofuranyl alkylsulfonate herbicides, including benfuresate, and ethofumesate; benzothiazole herbicides, including benazolin, benzthiazuron, fenthiaprop, mefenacet, and methabenzthiazuron; carbamate herbicides, including asulam, carboxazole, chlorprocarb, dichlormate, fenasulam, karbutilate, and terbucarb; carbanilate herbicides, including barban, BCPC, carbasulam, carbetamide, CEPC, chlorbufam, chlorpropham, CPPC, desmedipham, phenisopham, phenmedipham, phenmedipham-ethyl, propham, and swep; cyclohexene oxime herbicides, including alloxydim, butroxydim, clethodim, cloproxydim, cycloxydim, profoxydim, sethoxydim, tepraloxydim, and tralkoxydim; cyclopropylisoxazole herbicides, including isoxachlortole, and isoxaflutole; dicarboximide herbicides, including cinidon-ethyl, flumezin, flumiclorac, flumioxazin, and flumipropyn; dinitroaniline herbicides, including benfluralin, butralin, dinitramine, ethalfluralin, fluchloralin, isopropalin, methalpropalin, nitralin, oryzalin, pendimethalin, prodiamine, profluralin, and trifluralin; dinitrophenol herbicides, including dinofenate, dinoprop, dinosam, dinoseb, dinoterb, DNOC, etinofen, and medinoterb; diphenyl ether herbicides, including ethoxyfen, nitrophenyl ether herbicides, including acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen, oxyfluorfen, dithiocarbamate herbicides, including dazomet, and metam; halogenated aliphatic herbicides, including alorac, chloropon, dalapon, flupropanate, hexachloroacetone, iodomethane, methyl bromide, monochloroacetic acid, SMA, and TCA; imidazolinone herbicides, including imazamethabenz, imazamox, imazapic, imazapyr, imazaquin, and imazethapyr; inorganic herbicides, including ammonium sulfamate, borax, calcium chlorate, copper sulfate ferrous sulfate, potassium azide, potassium cyanate, sodium azide, sodium chlorate, and sulfuric acid; nitrile herbicides, including bromobonil, bromoxynil, chloroxynil, dichlobenil, iodobonil, ioxynil, and pyraclonil; organophosphorus herbicides, including amiprofos-methyl, anilofos, bensulide, bilanafos, butamifos, 2,4-DEP, DMPA, EBEP, fosamine, glufosinate, glufosinate-P, glyphosate, and piperophos; oxadiazolone herbicides, including dimefuron, methazole, oxadiargyl, and oxadiazon; oxazole herbicides, including carboxazole, isouron, isoxaben, isoxachlortole, isoxaflutole, monisouron, pyroxasulfone, and topramezone; phenoxy herbicides, including bromofenoxim, clomeprop, 2,4-DEB, 2,4-DEP, difenopenten, disul, erbon, etnipromid, fenteracol, and trifopsime; phenoxyacetic herbicides, including 4-CPA, 2,4-D, 3,4-DA, MCPA, MCPA-thioethyl, and 2,4,5-T; phenoxybutyric herbicides, including 4-CPB, 2,4-DB, 3,4-DB, MCPB, and 2,4,5-TB; phenoxypropionic herbicides, including cloprop, 4-CPP, dichlorprop, dichlorprop-P, 3,4-DP, fenoprop, mecoprop, and mecoprop-P; aryloxyphenoxypropionic herbicides, including chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P, and trifop; phenylenediamine herbicides, including dinitramine, and prodiamine; pyrazole herbicides, including azimsulfuron, difenzoquat, halosulfuron, metazachlor, pyrazosulfuron, and pyroxasulfone; benzoylpyrazole herbicides, including benzofenap, pyrasulfotole, pyrazolynate, pyrazoxyfen, and topramezone; phenylpyrazole herbicides, including fluazolate, nipyraclofen, and pyraflufen; pyridazine herbicides, including credazine, pyridafol, and pyridate; pyridazinone herbicides, including brompyrazon, chloridazon, dimidazon, flufenpyr, metflurazon, norflurazon, oxapyrazon, and pydanon; pyridine herbicides, including aminopyralid, cliodinate, clopyralid, diflufenican, dithiopyr, flufenican, fluroxypyr, haloxydine, picloram, picolinafen, pyriclor, pyroxsulam, thiazopyr, and triclopyr; pyrimidinediamine herbicides, including iprymidam, and tioclorim; quaternary ammonium herbicides, including cyperquat, diethamquat, difenzoquat, diquat, morfamquat, and paraquat; thiocarbamate herbicides, including butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate, and vernolate; thiocarbonate herbicides, including dimexano, EXD, and proxan; thiourea herbicides, including methiuron; triazine herbicides, including dipropetryn, triaziflam, and trihydroxytriazine; chlorotriazine herbicides, including atrazine, chlorazine, cyanazine, cyprazine, eglinazine, ipazine, mesoprazine, procyazine, proglinazine, propazine, sebuthylazine, simazine, terbuthylazine, and trietazine; methoxytriazine herbicides, including atraton, methometon, prometon, secbumeton, simeton, and terbumeton; methylthiotriazine herbicides, includingametryn, aziprotryne, cyanatryn, desmetryn, dimethametryn, methoprotryne, prometryn, simetryn, terbutryn, triazinone herbicides, including ametridione, amibuzin, hexazinone, isomethiozin, metamitron, metribuzin, triazole herbicides, including amitrole, cafenstrole, epronaz, and flupoxam; triazolone herbicides, including amicarbazone, bencarbazone, carfentrazone, flucarbazone, ipfencarbazone, propoxycarbazone, sulfentrazone, and thiencarbazone; triazolopyrimidine herbicides, including cloransulam, diclosulam, florasulam, flumetsulam, metosulam, penoxsulam, pyroxsulam, uracil herbicides, including benzfendizone, bromacil, butafenacil, flupropacil, isocil, lenacil, saflufenacil, and terbacil; urea herbicides, including benzthiazuron, cumyluron, cycluron, dichloralurea, diflufenzopyr, isonoruron, isouron, methabenzthiazuron, monisouron, and noruron; phenylurea herbicides, including anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, and thidiazuron; sulfonylurea herbicides; pyrimidinylsulfonylurea herbicides, including amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron, and trifloxysulfuron; triazinylsulfonylurea herbicides, including chlorsulfuron, cinosulfuron, ethametsulfuron, iodosulfuron, metsulfuron, prosulfuron, thifensulfuron, triasulfuron, tribenuron, triflusulfuron, and tritosulfuron; thiadiazolylurea herbicides, including buthiuron, ethidimuron, tebuthiuron, thiazafluron, and thidiazuron; and unclassified herbicides, including acrolein, allyl alcohol, aminocyclopyrachlor, azafenidin, bentazone, benzobicyclon, buthidazole, calcium cyanamide, cambendichlor, chlorfenac, chlorfenprop, chlorflurazole, chlorflurenol, cinmethylin, clomazone, CPMF, cresol, cyanamide, ortho-dichlorobenzene, dimepiperate, endothal, fluoromidine, fluridone, flurochloridone,flurtamone, fluthiacet, indanofan, methyl isothiocyanate, OCH, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan, and tritac.

19. The method of claim 17, wherein said herbicide is glyphosate.

20. The method of claim 19, wherein said glyphosate is a glyphosate salt selected from the diammonium salt of glyphosate, the isopropylamine salt of glyphosate, and the trimethylsulfonium salt of glyphosate.

21. The method of claim 14, wherein said formulation further comprises gamma-aminobutyrate, at least one herbicide, and at least one member of the group consisting of an insecticide, an acaracide, a nematicide, and a molluscicide.

22. The method of claim 14, wherein said formulation further comprises a source of proteinaceous amino acids.

23. The method of claim 14, wherein said formulation further comprises an effective amount of glutamic acid.

24. The method of claim 15, wherein the insecticide is imidacloprid.

25. The method of claim 14, wherein said plant is selected from the group consisting of cereals, beet, leguminous plants, oil plants, cucumber plants, fiber plants, vegetables, ornamentals, and herbs.

26. The method of claim 14, wherein said plant is selected from the group consisting of wheat, barley, rye, oats, corn, sweet corn, rice, sorghum, triticale, forage and turf grasses, sugar beet, fodder beet, beet root, beans, pinto beans, navy beans, lima beans, lentils, peas, chickpeas, soybeans, alfalfa, clover, peanuts, rape, mustard, sunflowers, canola, cucurbits, marrows, cucumbers, pumpkins, melons, gourds, zucchini, cotton, flax, hemp, jute, spinach, lettuce, endive, cress, corn salad, asparagus, cabbages, cauliflower, brussels sprout, broccoli, Kale, Rapini, Bok choy, Kai-lan, Komatsuna, Mizuna greens, celeriac celery, leeks, carrots, onions, tomatoes, bell peppers, chili peppers, potatoes, paprika, radishes, duckweed, egg plants, conifers, basil, oregano, parsley, thyme, tobacco, fruits, nuts, crops, ornamentals and hydroponically grown plants.

27. A method of alleviating at least one of anticipated stress and anticipated phytotoxic symptoms in a plant, comprising applying an effective amount of the formulation of claim 1 on a plant in need of at least one of alleviation of anticipated stress and alleviation of anticipation of phytotoxic symptoms.

28. The method of claim 14, wherein said anticipated stress and said anticipated phytotoxic symptoms occur or are anticipated to occur as a result of at least one of the application of insecticides or acaricides to plants, the application of herbicides to herbicide resistant plants, and the application of herbicides to herbicide tolerant plants.

29. A formulation comprising at least one compound selected from the group consisting of aspartame, azelaic acid, gamma-aminobutyric acid, a metabolic primer, and an amino acid precursor; combined with at least one pesticide selected from the group consisting of an insecticide, an acaracide, a nematicide, a molluscicide and a herbicide.
